(19) United States
(12) Patent Application Publication
(10) Pub. No.: US 2025/0077889 A1
(43) Pub. Date: Mar. 6, 2025

(54) COMPUTER-READABLE RECORDING MEDIUM STORING INFORMATION PROCESSING PROGRAM, INFORMATION PROCESSING APPARATUS, AND INFORMATION PROCESSING METHOD

(71) Applicant: Fujitsu Limited, Kawasaki-shi (JP)

(72) Inventor: Shingo OKUNO, Kawasaki (JP)

(73) Assignee: Fujitsu Limited, Kawasaki-shi (JP)

(21) Appl. No.: 18/765,441

(22) Filed: Jul. 8, 2024

(30) Foreign Application Priority Data
Aug. 29, 2023 (JP) 2023-138931

(51) Int. Cl. G06N 3/098

(52) U.S. Cl. CPC G06N 3/098

(57) ABSTRACT

A non-transitory computer-readable recording medium stores an information processing program for causing a processor of an information processing apparatus that manages distributed training that uses a plurality of nodes to execute a process. The process includes: obtaining a waiting time until a resource to be used for the distributed training is secured and an execution time taken for the distributed training, for each of execution environments of different numbers of nodes; obtaining a score for each of the execution environments based on the waiting time and the execution time acquired for each of the execution environments; and determining the number of nodes to be used for the distributed training based on a plurality of the scores.

### CROSS-REFERENCE TO RELATED APPLICATION

This application is based upon and claims the benefit of priority of the prior Japanese Patent Application No. 2023-138931, filed on Aug. 29, 2023, the entire contents of which are incorporated herein by reference.

### FIELD

The embodiment discussed herein is related to a computer-readable recording medium storing an information processing program, an information processing apparatus, and an information processing method.

### BACKGROUND

A multiple neural network (MNN) including a plurality of neural networks (NNs) has been known in recent years. For example, a high-dimensional neural network potential (HDNNP) that calculates potential energy of an entire particle system by using the MNN is known.

Japanese Laid-open Patent Publication Nos. 2013-140490 and 2015-118434, and U.S. Patent Application Publication Nos. 2015/0169380, 2014/0075446, and 2020/0236060 are disclosed as related art.

### SUMMARY

According to an aspect of the embodiments, a non-transitory computer-readable recording medium stores an information processing program for causing a processor of an information processing apparatus that manages distributed training that uses a plurality of nodes to execute a process. The process includes: obtaining a waiting time until a resource to be used for the distributed training is secured and an execution time taken for the distributed training, for each of execution environments of different numbers of nodes; obtaining a score for each of the execution environments based on the waiting time and the execution time acquired for each of the execution environments; and determining the number of nodes to be used for the distributed training based on a plurality of the scores.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing system according to one embodiment;

FIG. 2 is a diagram illustrating the number of amino acid residues constituting a TrpCage protein;

FIG. 3 is a block diagram illustrating an example of a hardware (HW) configuration of a computer that realizes a function of a system management device of the information processing system according to the one embodiment;

FIG. 4 is a diagram illustrating examples of allocation patterns of residues to an execution node group in the information processing system according to the one embodiment;

FIG. 5 is a diagram for describing prediction calculation information in the information processing system according to the one embodiment;

FIG. 6 illustrates an example in which a performance prediction job is executed using backfill scheduling;

FIG. 7 is a diagram for describing a method of determining a maximum computation time in the information processing system according to the one embodiment;

FIG. 8 is a diagram illustrating an execution example of a queue state display command in the information processing system according to the one embodiment;

FIG. 9 is a diagram illustrating reference information to which a parallel number determination unit of the information processing system according to the one embodiment refers;

FIG. 10 is a flowchart for describing processing of the system management device of the information processing system according to the one embodiment; and

FIG. 11 is a flowchart for describing details of processing in step S2 of the flowchart illustrated in FIG. 10.

### DESCRIPTION OF EMBODIMENTS

As a training method for such an MNN, distributed training in which machine learning (training) is performed in parallel on a plurality of NNs included in the MNN may be used. In the distributed training of the MNN, the NN is allocated to each of a plurality of workers, and calculation results (outputs) of the respective workers are distributed to each other by Allreduce communication. After that, a total sum of the outputs calculated by the respective workers is individually calculated, and an average of gradients or the like is calculated.

The worker is an arithmetic device such as a central processing unit (CPU) or a graphics processing unit (GPU) included in a computation node (hereafter, simply referred to as a node). In a case where the worker is a GPU, one worker=one GPU may be set. In a case where the worker is a CPU, one worker=one CPU may be set, one worker=one core may be set, and the implementation may be modified as appropriate. Hereinafter, in the training of the MNN, the node that executes processing related to the training may be referred to as an execution node.

By increasing a parallel number, for example, the number of workers to be used in the distributed training, it is possible to shorten an arithmetic operation execution time in each worker. However, in the distributed training, communication between the workers occurs by performing the Allreduce communication. Communication is a generally costly process, and for example, the cost of communication performed between execution nodes is high. Communication performed between the execution nodes may be referred to as internode communication.

In the distributed training, it is desirable to perform worker deployment that minimizes the number of internode communications.

For example, in a case where a usage fee increases or decreases in accordance with the number of execution nodes such as a cloud computing system or a supercomputer, the usage fee increases when the number of execution nodes increases.

In a multi-tenant environment in which a plurality of users shares a system, as the number of execution nodes increases, a time taken to secure a resource increases, and a waiting time until job execution increases.

Accordingly, when the distributed training is performed, it is desired to determine the optimum degree of parallelism.

In one aspect, an object of the present disclosure is to enable determination of the optimum degree of parallelism for realizing distributed training.

Hereinafter, an embodiment related to an information processing program, an information processing apparatus, and an information processing method will be described with reference to the drawings. However, the embodiment described below is merely an example, and is not intended to exclude the application of various modification examples and techniques that are not explicitly described in the embodiment. For example, the present embodiment may be variously modified and implemented within a scope not departing from the gist thereof. Each drawing is not intended to indicate that only constituent elements illustrated in the drawing are included, and other functions or the like may be included.

### (A) Configuration

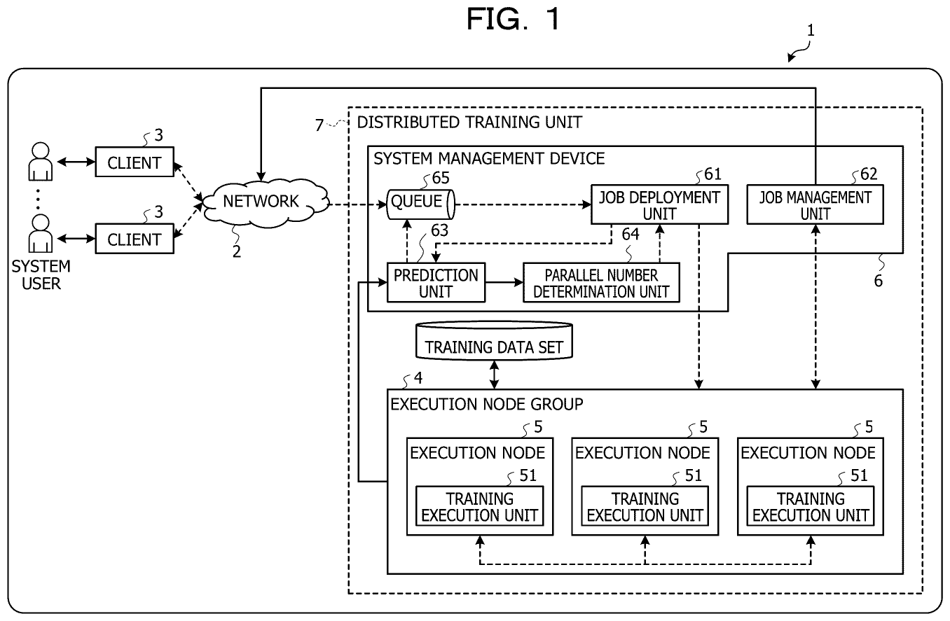

FIG. 1 is a diagram schematically illustrating a configuration of an information processing system 1 according to one embodiment.

The information processing system 1 realizes data parallel distributed training by using a plurality of execution nodes 5. The information processing system 1 illustrated in FIG. 1 includes a distributed training unit 7 and a plurality of client terminals 3. These distributed training unit 7 and plurality of client terminals 3 are communicably coupled to each other via a network 2.

The information processing system 1 supports a multi-tenant environment shared by a plurality of users and includes the plurality of client terminals 3.

The client terminal 3 is a terminal device used by a user of the information processing system 1, and input or the like of a job is performed via the client terminal 3, for example. Training data (dataset) to be used for distributed training may be input via the client terminal 3.

For example, the network 2 may be a local area network (LAN) such as Ethernet, optical communication such as Fibre Channel (FC), or the like.

The distributed training unit 7 includes a system management device 6 and an execution node group 4.

The execution node group 4 includes the plurality of execution nodes 5. The execution node 5 is an information processing apparatus (computer) including one or more processors, a memory, a storage device, and the like (not illustrated), and realizes a function as a training execution unit 51 by executing an operating system (OS) and a program stored in the storage device. The processor included in the execution node 5 is an example of a worker.

In the present embodiment, an example in which there is no difference or substantially no difference in performance among the plurality of execution nodes 5 included in the execution node group 4 will be described. However, the embodiment is not limited to this, and there may be a performance difference among the execution nodes 5, and the configuration may be changed as appropriate.

The training execution unit 51 trains an NN. The respective NNs of the plurality of execution nodes 5 included in the execution node group 4 constitute an MNN.

An example in which the information processing system 1 is applied to HDNNP for a TrpCage protein coarse-grained on an amino acid residue basis will be described. For example, residues constituting a protein are treated as a particle system, and potential energy of the entire particle system is calculated by a machine learning model. TrpCage is a protein composed of 20 amino acid residues.

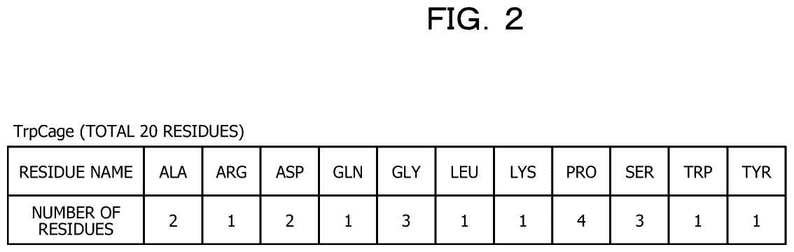

FIG. 2 is a diagram illustrating the number of amino acid residues constituting a TrpCage protein.

FIG. 2 illustrates a combination of 20 residues of 11 types constituting the TrpCage.

For distributed training using the plurality of execution nodes 5 in the execution node group 4, the NN is prepared for each residue, and each NN corresponds to any of 11 types of residues in the TrpCage.

Hereinafter, the NN may be specified by adding a subscript representing a residue name of a protein to the NN. For example, an NN corresponding to proline (PRO) is represented by NN_{PRO}, and an NN corresponding to tyrosine (TYR) is represented by NN_{TYR}.

At the execution node 5, the training execution unit 51 may train the NN corresponding to any of the 11 types of residues of the TrpCage.

For example, the training execution unit 51 inputs input data to an input layer of the NN, and sequentially executes predetermined calculation in a hidden layer composed of a convolutional layer, a pooling layer, and the like, thereby executing forward direction processing (forward propagation processing) of sequentially transmitting information obtained by the arithmetic operation from the input side to the output side. After the forward direction processing is executed, the training execution unit 51 executes backward direction processing (back propagation processing) of determining parameters used in the forward direction processing for reducing a value of an error function obtained from correct answer data and output data output from an output layer.

Based on the result of the back propagation processing, update processing for updating variables such as weights is executed. For example, as an algorithm for determining an update width of the weight used in the calculation in the back propagation processing, gradient descent may be used.

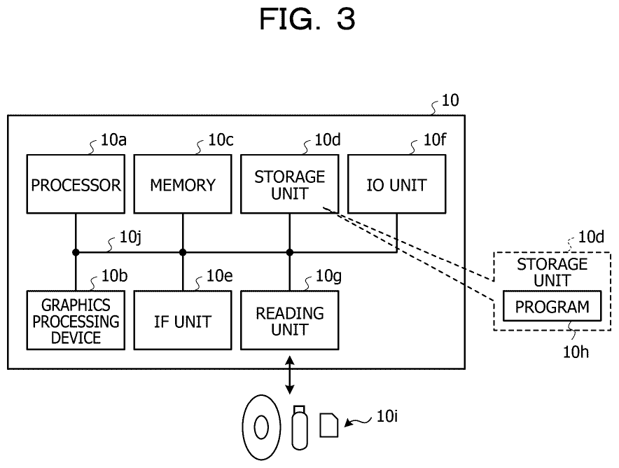

FIG. 3 is a block diagram illustrating an example of a hardware (HW) configuration of a computer 10 that realizes functions of the system management device 6 of the information processing system 1 according to the one embodiment. In a case where a plurality of computers is used as an HW resource for realizing the functions of the system management device 6, each computer may have the HW configuration illustrated in FIG. 3.

As illustrated in FIG. 3, the computer 10 may exemplarily include a processor 10a, a graphics processing device 10b, a memory 10c, a storage unit 10d, an interface (IF) unit 10e, an input/output (IO) unit 10f, and a reading unit 10g, as the HW configuration.

The processor 10a is an example of an arithmetic processing device that performs various controls and arithmetic operations and is an example of a control unit. The processor 10a may be coupled to each block in the computer 10 via a bus 10j to be able to communicate with each other. The processor 10a may be a multiprocessor including a plurality of processors or a multi-core processor including a plurality of processor cores, or may have a configuration including a plurality of multi-core processors.

Examples of the processor 10a include integrated circuits (ICs) such as a CPU, an MPU, an APU, a DSP, an ASIC, and an FPGA. A combination of two or more of these integrated circuits may be used as the processor 10a. CPU is an abbreviation for central processing unit, and MPU is an abbreviation for microprocessor unit. APU is an abbreviation for accelerated processing unit. DSP is an abbreviation for digital signal processor, ASIC is an abbreviation for application specific IC, and FPGA is an abbreviation for field-programmable gate array.

The graphics processing device 10b performs screen display control for an output device such as a monitor in the IO unit 10f. Examples of the graphics processing device 10b include various arithmetic processing devices, for example, ICs such as a GPU, an APU, a DSP, an ASIC, and an FPGA.

The memory 10c is an example of hardware (HW) that stores information such as various types of data and programs. Examples of the memory 10c include one or both of a volatile memory such as a dynamic random-access memory (DRAM) and a nonvolatile memory such as a persistent memory (PM).

The storage unit 10d is an example of HW that stores information such as various types of data and programs. Examples of the storage unit 10d include a magnetic disk device such as a hard disk drive (HDD), a semiconductor drive device such as a solid-state drive (SSD), and various storage devices such as a nonvolatile memory. Examples of the nonvolatile memory include a flash memory, a storage class memory (SCM), a read-only memory (ROM), and the like.

The storage unit 10d may store a program 10h (information processing program) that realizes all or some of various functions of the computer 10.

For example, the processor 10a of the system management device 6 (computer 10) loads the program 10h stored in the storage unit 10d into the memory 10c and executes the program 10h to realize a distributed training control function to be described later.

The IF unit 10e is an example of a communication IF that performs, for example, control or the like of coupling and communication between this computer 10 and another computer. For example, the IF unit 10e may include an adapter conforming to a LAN such as Ethernet (registered trademark) or optical communication such as FC. This adapter may support one or both of a wireless communication method and a wired communication method.

For example, the system management device 6 may be coupled to each of the client terminals 3 and the execution node group 4 illustrated in FIG. 1 to be able to communicate with each other via the IF unit 10e and the network 2. The program 10h may be downloaded from the network 2 to the computer 10 via this IF unit 10e and stored in the storage unit 10d.

The IO unit 10f may include one or both of an input device and an output device. Examples of the input device include a keyboard, a mouse, a touch panel, and the like. Examples of the output device include a monitor, a projector, a printer, and the like. The IO unit 10f may include a touch panel or the like in which an input device and a display device are integrated. The output device may be coupled to the graphics processing device 10b.

The reading unit 10g is an example of a reader that reads information of programs and data recorded in a recording medium 10i. The reading unit 10g may include a coupling terminal or device to which the recording medium 10i may be coupled or inserted. Examples of the reading unit 10g include an adapter that conforms to Universal Serial Bus (USB) or the like, a drive device that accesses a recording disk, a card reader that accesses a flash memory such as a secure digital (SD) card, and the like. The program 10h may be stored in the recording medium 10i, and the reading unit 10g may read the program 10h from the recording medium 10i and store the program 10h in the storage unit 10d.

Examples of the recording medium 10i include a non-transitory computer-readable recording medium such as a magnetic/optical disk or a flash memory. Examples of the magnetic/optical disk include a flexible disk, a compact disc (CD), a Digital Versatile Disc (DVD), a Blu-ray disc, a holographic versatile disc (HVD), and the like. Examples of the flash memory include a semiconductor memory such as a USB memory or an SD card.

The HW configuration of the computer 10 described above is an example. Accordingly, an increase or decrease (for example, addition or deletion of an arbitrary block), division, or integration in an arbitrary combination of the HW in the computer 10, or addition, deletion, or the like of a bus may be appropriately performed.

### (B) Functional Configuration Example of System Management Device 6

As illustrated in FIG. 1, the system management device 6 has functions as a job deployment unit 61, a job management unit 62, a prediction unit 63, a parallel number determination unit 64, and a queue 65.

A job received from the client terminal 3 via the network 2 is stored in the queue 65. The job input to the queue 65 may be output in a first in first out (FIFO) manner, for example.

The job management unit 62 manages an execution state of a job in each execution node 5. As described above, the job management unit 62 manages (monitors) the execution state of the job in each execution node 5, thereby determining whether a job each execution node 5 is running or finished. As a result, the job management unit 62 may give us statuses such as empty and waiting of each execution node 5.

The prediction unit 63 predicts execution performance (parallel performance) in a plurality of execution environments in which the numbers of execution nodes 5 (execution node number) to be used are different, in a case where distributed training is performed by using the plurality of execution nodes 5.

The prediction unit 63 generates a job for predicting execution performance and inputs the job to the queue 65.

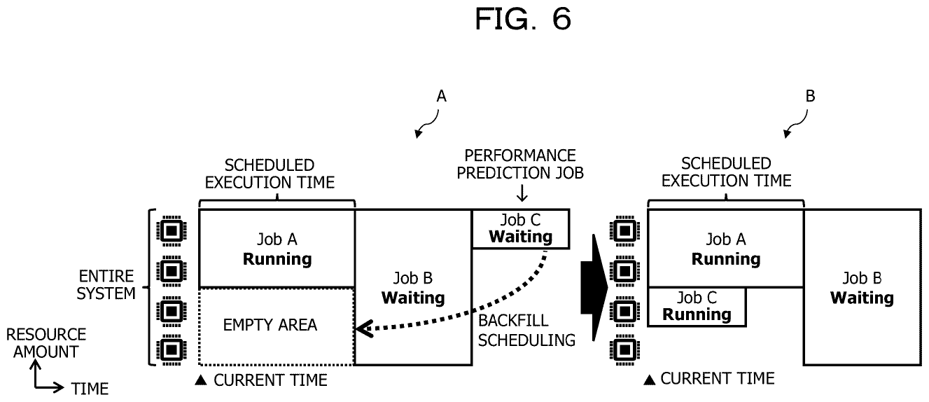

The job for performance prediction extracted from the queue 65 is allocated to the execution node 5 by the job deployment unit 61 described later. Because an execution time upper limit value of the job for performance prediction is also set to be small, it is expected that a waiting time for a job to run is shortened by backfill scheduling in FIG. 6.

The prediction unit 63 receives the result of the job for performance prediction from the execution node group 4 and predicts execution performance. As the job, the prediction unit 63 allocates residues constituting the protein to the execution nodes 5. The number of execution nodes 5 used for the job allocation may be referred to as an execution node number.

The prediction unit 63 creates a plurality of allocation patterns while changing the execution node number. The plurality of allocation patterns of different execution node numbers are examples of execution environments of different node numbers.

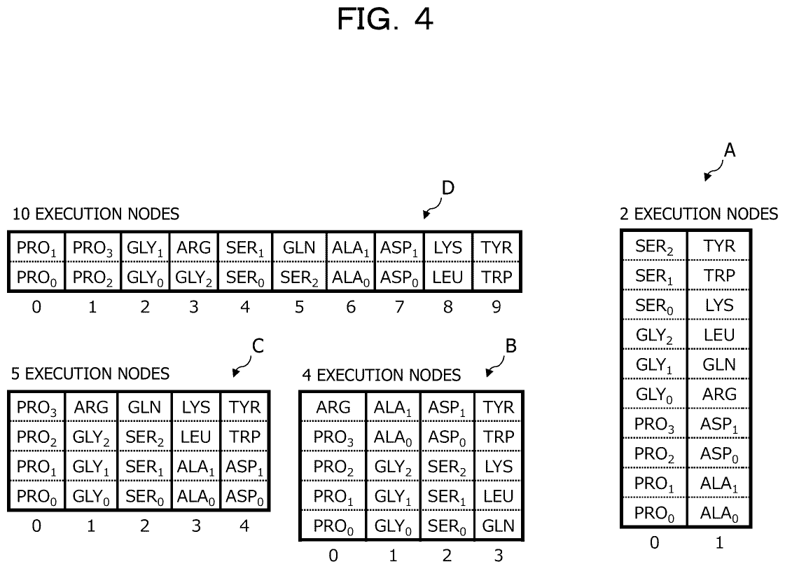

FIG. 4 is a diagram illustrating examples of allocation patterns of residues to the execution node group 4 in the information processing system 1 according to the one embodiment.

The example illustrated in FIG. 4 indicates four allocation patterns in which 20 residues of 11 types constituting the TrpCage protein illustrated in FIG. 2 are allocated while changing the execution node number.

In FIG. 4, a reference sign A indicates an allocation pattern in which the execution node number is 2 (two apparatuses), a reference sign B indicates an allocation pattern in which the execution node number is 4 (four apparatuses), a reference sign C indicates an allocation pattern in which the execution node number is 5 (five apparatuses), and a reference sign D indicates an allocation pattern in which the execution node number is 10 (ten apparatuses), respectively.

Each allocation pattern is associated with a specific execution node number. A plurality of allocation patterns may be referred to as a node number group.

In a case where the node number group is represented as a set N, the example illustrated in FIG. 4 indicates four allocation patterns, and it may be represented as N={2, 4, 5, 10}.

In each allocation pattern illustrated in FIG. 4, each column indicates the execution node 5, and a numerical value (for example, 0 to 9 in the example indicated by the reference sign D) given to each column functions as identification information for specifying the execution node 5. Hereinafter, the identification information for specifying the execution node 5 may be referred to as an execution node ID. The execution node ID may be an integer.

Hereinafter, the execution node 5 may be specified by using a reference sign #and the execution node ID. For example, the execution node 5 having an execution node ID of 0 may be represented as an execution node #0.

For example, in the allocation pattern indicated by the reference sign C in FIG. 4, four prolines (PRO₀ to PRO₃) are allocated to the execution node #0. For example, it is represented that this execution node #0 performs training of the NN_{PRO} as a job.

At the time of allocating the job (residue) to the execution node 5 of each allocation pattern, the prediction unit 63 may determine an allocation destination by solving a bin packing problem. At this time, the execution node number is set as the number of bins.

As a first strategy for the bin packing, the prediction unit 63 allocates residues such that the number of residues is equal among the execution nodes 5 from the viewpoint of load balancing.

Balancing the load among the execution nodes 5 may be realized by setting the execution node number (the number of bins) to a divisor (for example, 2, 4, 5, 10) of the total number of residues (20 in the present embodiment).

As a second strategy of the bin packing, the prediction unit 63 allocates jobs so that the same residue type is allocated in the same execution node 5 as much as possible in order to minimize the number of communications across the execution nodes 5. As a result, it is possible to reduce the possibility of such communications across the execution nodes 5 in the Allreduce communication.

When determining the allocation pattern of each execution node number, the prediction unit 63 may allocate the residues to the plurality of execution nodes 5 based on a worst-fit decreasing (WFD) algorithm.

When residues are allocated to the execution node 5 by the WFD algorithm, a residue type having a large number of residues is allocated first. The residue is deployed to an execution node 5 having a maximum empty space among the execution nodes 5 satisfying the capacity. As a result, it is possible to reduce the probability of allocating the residue type having a large number of residues across the execution nodes 5.

The prediction unit 63 predicts a computation time (predicted computation time) corresponding to the number of residues, based on a measurement result of a cumulative computation time taken for forward propagation per epoch, which is obtained as a result of actually causing the execution node 5 to train 11 types of residues in the TrpCage.

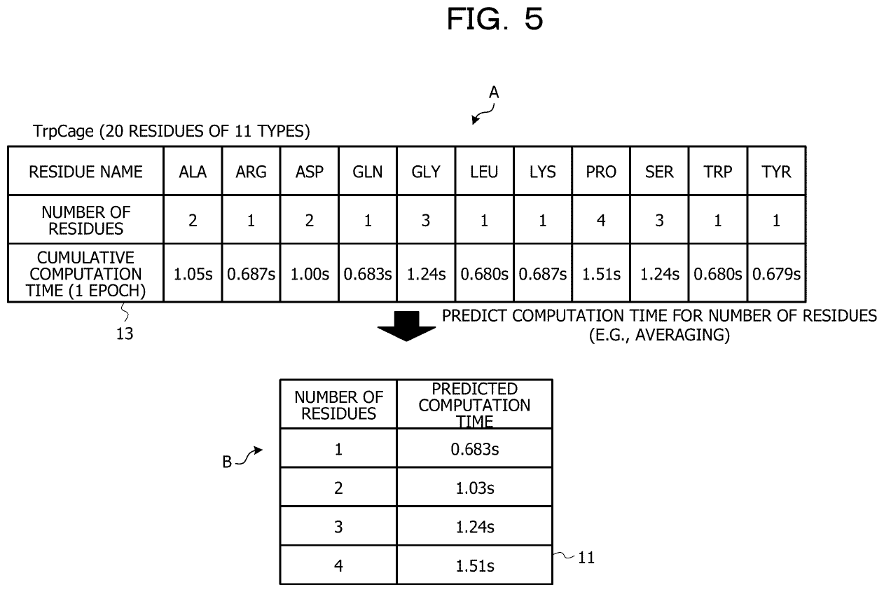

FIG. 5 is a diagram for describing predicted computation time information 11 in the information processing system 1 according to the one embodiment.

In this FIG. 5, a reference sign A illustrates actually measured cumulative computation time information 13 and a reference sign B illustrates the predicted computation time information 11.

The actually measured cumulative computation time information 13 indicates the number of residues and a cumulative computation time for each of the plurality of residues constituting the TrpCage.

The cumulative computation time is a measurement result (measurement value) taken for the forward propagation per epoch, which is obtained as a result of experimentally causing one execution node 5 included in the execution node group 4 to train for each of 11 types of residues constituting the TrpCage as a performance prediction job. The cumulative computation time may be referred to as an actually measured cumulative computation time. The cumulative computation time is an example of a measurement result obtained by causing one execution node 5 among the plurality of execution nodes 5 to execute processing related to distributed training.

For example, a cumulative computation time for tyrosine (TYR) with one residue is 0.679 s, while a cumulative computation time for proline (PRO) with four residues is 1.51 s, and it is seen that the computation time for forward propagation increases in proportion to the number of pieces of input data (the number of residues).

Since the training (machine learning) of the NN has a characteristic of repeatedly executing processing until an end condition (for example, the predetermined number of epochs is reached, a loss is equal to or less than a threshold value, or the like) is satisfied, it is possible to perform performance prediction with high accuracy even by execution of several iterations. Therefore, as the performance prediction job, it is possible to perform performance prediction with high prediction accuracy by using the measurement result of the cumulative computation time obtained by causing the execution node 5 to execute only one epoch.

To minimize the computation time taken for the performance prediction by the prediction unit 63, an execution waiting time of the job related to the performance prediction may be shortened by using backfill scheduling.

FIG. 6 illustrates an example in which the performance prediction job is executed using backfill scheduling.

In FIG. 6, a reference sign A indicates a state before backfill scheduling is applied and a reference sign B indicates a state after backfill scheduling is applied.

In a process of securing computation resources (workers) in order from a job having a high priority, in a case where it is possible to execute a performance prediction job (Job C) by using an empty resource that is not used by any job, the performance prediction job (Job C) is executed before a job (Job B) having a high priority.

By using a method such as backfill scheduling, the prediction unit 63 may minimize the computation time taken for the performance prediction.

By using the cumulative computation time measured in this manner, the prediction unit 63 creates the actually measured cumulative computation time information 13.

The prediction unit 63 predicts a predicted computation time for each number of residues based on an actually measured cumulative computation time in the actually measured cumulative computation time information 13. According to the example illustrated in FIG. 5, the prediction unit 63 calculates (predicts) a predicted computation time for each of the numbers of residues of 1 to 4.

As in the case of the number of residues of 2 or the number of residues of 4 in the example indicated by the reference sign A in FIG. 5, when the same number of residues are present in a plurality of residue types (residue names), the prediction unit 63 may calculate an average value of the cumulative computation times of these numbers of residues as the predicted computation time.

For example, in the example indicated by the reference signs A and B in FIG. 5, the numbers of residues of two of residue names ALA and ASP are 2. The prediction unit 63 calculates (predicts) an average value 1.03 s of the cumulative computation time 1.05 s of the residue name ALA and the cumulative computation time 1.00 s of the residue name ASP as a predicted computation time of the number of residues of 2.

By associating the calculated predicted computation time with the number of residues, the prediction unit 63 creates the predicted computation time information 11. For example, the predicted computation time information 11 may be stored in a predetermined storage area of the memory 10c or the storage unit 10d.

For each of the plurality of created allocation patterns (see FIG. 4), the prediction unit 63 calculates (predicts) a computation time (predicted cumulative computation time) for each execution node 5 used in the allocation pattern and specifies an execution node 5 having a longest predicted cumulative computation time for each allocation pattern. For the plurality of execution nodes 5 included in the allocation pattern, the longest predicted cumulative computation time may be referred to as a maximum computation time.

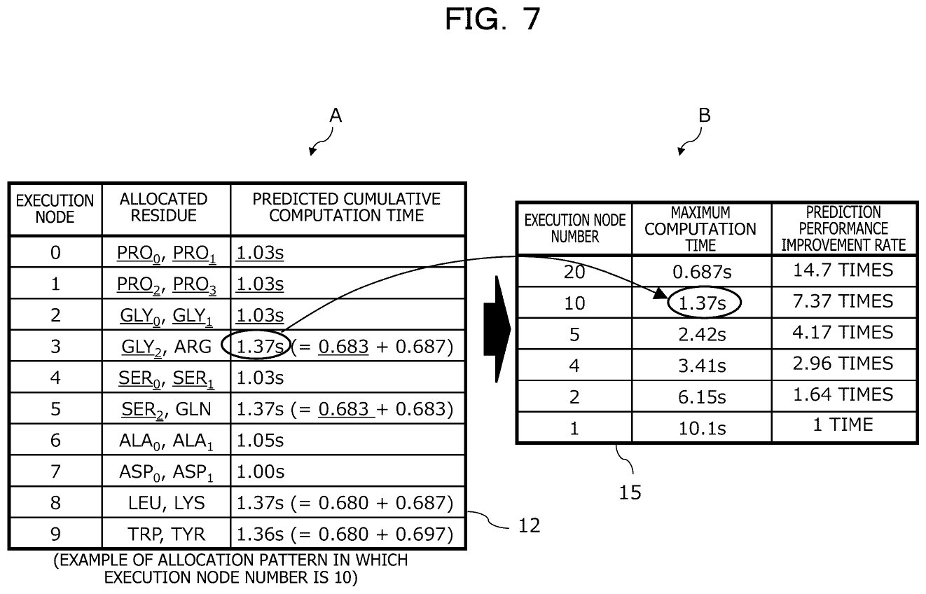

FIG. 7 is a diagram for describing a method of determining a maximum computation time in the information processing system 1 according to the one embodiment.

In this FIG. 7, a reference sign A indicates an example of predicted cumulative computation time information 12 indicating the predicted cumulative computation time of each execution node 5 in the allocation pattern in which the execution node number is 10 illustrated in FIG. 4. The predicted cumulative computation time information 12 illustrated in FIG. 7 is configured such that the allocated residue and the predicted cumulative computation time are associated with the execution node.

The execution node is a value for specifying the execution node 5, and in the example illustrated in FIG. 7, the execution node 5 is specified by using an execution node ID.

The allocated residue is a residue (allocated residue) allocated to each execution node 5. The predicted cumulative computation time is a time (cumulative time) taken for processing (training of NN) per epoch for the allocated residues in each execution node 5.

Among the allocated residues indicated in the predicted cumulative computation time information 12, residues which are residues of the same type are allocated in a distributed manner to the plurality of execution nodes 5 are indicated with an underline. For example, residues indicated with an underline in the predicted cumulative computation time information 12 illustrated in FIG. 7 are node crossing residues allocated across the execution nodes 5. In FIG. 7, the predicted cumulative computation time corresponding to the node crossing residue is also indicated with an underline.

Based on the predicted computation time information 11, the prediction unit 63 creates the predicted cumulative computation time information 12.

For the node crossing residue, the prediction unit 63 extracts, from the predicted computation time information 11, a predicted computation time corresponding to the number of residues for which the same residue type is allocated, and uses the predicted computation time to calculate the predicted cumulative computation time in the predicted cumulative computation time information 12.

For example, in FIG. 7, two node crossing residues PRO₀ and PRO₁ are allocated to the execution node #0. The prediction unit 63 acquires the predicted computation time 1.03 s corresponding to the number of residues of 2 from the predicted computation time information 11, and sets the predicted computation time to the predicted cumulative computation time corresponding to the execution node #0 in the predicted cumulative computation time information 12.

For a residue that is not a node crossing residue, the prediction unit 63 extracts a cumulative computation time corresponding to the residue from the actually measured cumulative computation time information 13 and uses the cumulative computation time for calculation of the predicted cumulative computation time in the predicted cumulative computation time information 12.

For example, in FIG. 7, two residues ALA₀ and ALA₁ are allocated to an execution node #6. The prediction unit 63 acquires the actually measured cumulative computation time 1.05 s corresponding to the residue ALA from the actually measured cumulative computation time information 13, and sets the actually measured cumulative computation time to the predicted cumulative computation time corresponding to the execution node #6 in the predicted cumulative computation time information 12.

In FIG. 7, for example, two residues LEU and LYS are allocated to an execution node #8. From the actually measured cumulative computation time information 13, the prediction unit 63 acquires an actually measured cumulative computation time 0.680 s corresponding to the residue LEU and an actually measured cumulative computation time 0.687 s corresponding to the residue LYS. The prediction unit 63 sets, to the predicted cumulative computation time corresponding to the execution node #8 in the predicted cumulative computation time information 12, a value 1.37 s (=0.680+0.687) obtained by totaling these actually measured cumulative computation times.

There is also an execution node 5 to which both a node crossing residue and a residue that is not a node crossing residue are allocated. For such an execution node 5, the prediction unit 63 uses, as the predicted cumulative computation time, a value obtained by totaling the predicted computation time corresponding to the number of residues for which the same residue type is allocated, which is extracted from the predicted computation time information 11, and the cumulative computation time corresponding to the residue, which is extracted from the actually measured cumulative computation time information 13.

For example, in FIG. 7, one node crossing residue GLY₂ and a residue ARG that is not a node crossing residue are allocated to the execution node #3. The prediction unit 63 acquires a predicted computation time 0.683 s corresponding to the number of residues of 1 from the predicted computation time information 11, and acquires an actually measured cumulative computation time 0.687 s corresponding to the residue ARG from the actually measured cumulative computation time information 13. The prediction unit 63 sets a value 1.37 s obtained by totaling the predicted computation time 0.683 s and the actually measured cumulative computation time 0.687 s as the predicted cumulative computation time corresponding to the execution node #3 in the predicted cumulative computation time information 12.

As described above, the prediction unit 63 calculates the predicted cumulative computation times for all the execution nodes 5 in the predicted cumulative computation time information 12.

For each of the plurality of types of allocation patterns, the prediction unit 63 creates the predicted cumulative computation time information 12.

The prediction unit 63 acquires a maximum value of the predicted cumulative computation time in the created predicted cumulative computation time information 12. In the predicted cumulative computation time information 12 exemplified by the reference sign A in FIG. 7, the maximum value of the predicted cumulative computation time is 1.37 s.

For all the allocation patterns, the prediction unit 63 acquires a maximum value (maximum computation time) of the predicted cumulative computation time from each piece of the predicted cumulative computation time information 12.

By using the acquired maximum value (maximum computation time) of the predicted cumulative computation time of each allocation pattern, the prediction unit 63 creates prediction performance improvement rate information 15.

In FIG. 7, a reference sign B indicates an example of the prediction performance improvement rate information 15.

In the prediction performance improvement rate information 15 exemplified in FIG. 7, a maximum computation time and a prediction performance improvement rate are associated according to the execution node number.

The execution node number is the number of execution nodes 5, and is the number of execution nodes 5 used as allocation destinations of the residues (jobs). In the example indicated by the reference sign B in FIGS. 7, 1, 2, 4, 5, 10, and 20 are indicated as the execution node numbers. Among these execution node numbers, for the same number (2, 4, 5, and 10 in the example indicated in FIG. 4) as the number of execution nodes 5 used in the allocation pattern (see FIG. 4), it may be said that the execution node number specifies the allocation pattern.

The maximum computation time is a maximum value of the predicted cumulative computation time in each execution node number (allocation pattern). It may be said that the maximum computation time is the maximum value of the predicted value of the cumulative computation time for each execution node number (allocation pattern). In the example illustrated in FIG. 7, the value of the maximum computation time decreases as the execution node number increases, and the value of the maximum computation time increases as the execution node number decreases.

The prediction performance improvement rate is a value obtained by calculating a prediction performance improvement rate for a maximum computation time corresponding to each execution node number in a case where the maximum computation time when the execution node number is 1 is set as a reference. For example, the prediction performance improvement rate may be calculated by dividing the maximum computation time in a case where the execution node number is 1 by the maximum computation time for each execution node number.

For example, this prediction performance improvement rate may be a relative prediction performance improvement rate with respect to the maximum computation time when the execution node number is 1.

Based on a measurement result (cumulative computation time) obtained by causing one execution node 5 among the plurality of execution nodes 5 to execute processing related to distributed training, the prediction unit 63 calculates a prediction performance improvement rate for each of the plurality of allocation patterns (execution environments).

Based on the prediction performance improvement rate of the prediction performance improvement rate information 15, the prediction unit 63 calculates (predicts) an execution time Tₗ(n) when the distributed training is performed using n execution nodes 5. The execution time Tₗ(n) represents performance (parallel performance) when the distributed training is performed using n execution nodes 5.

For example, the prediction unit 63 calculates (predicts) the execution time Tₗ(n) for each execution node number by dividing a reference value of the execution time by the prediction performance improvement rate for each execution node number (n).

The reference value of the execution time may be, for example, an execution time upper limit value described in the job, which is determined in advance by the user. Although it is difficult to predict a training time (execution time of a program) of the NN in advance, it is possible to calculate (predict) the execution time Tₗ(n) for each execution node number by reflecting the prediction performance improvement rate calculated for each execution node number (n) in the execution time upper limit value described in the job. For example, the execution time upper limit value may be set by the user or may be defined in advance by a specification or the like.

The prediction unit 63 predicts a waiting time taken to secure the execution node 5 to be used, in a case where distributed training is performed by using the plurality of execution nodes 5.

For example, the prediction unit 63 may use a machine learning model (prediction model W) for predicting the waiting time to predict a waiting time T_{w} taken to secure the n execution nodes 5 as resources.

The prediction model W may be a model that predicts a waiting time when an execution status or a queue state of a job in the execution node 5 is input.

As the input data to the prediction model W, for example, information obtained as a result of executing a known command for displaying the execution status of the job or information (state) of the queue 65 may be used.

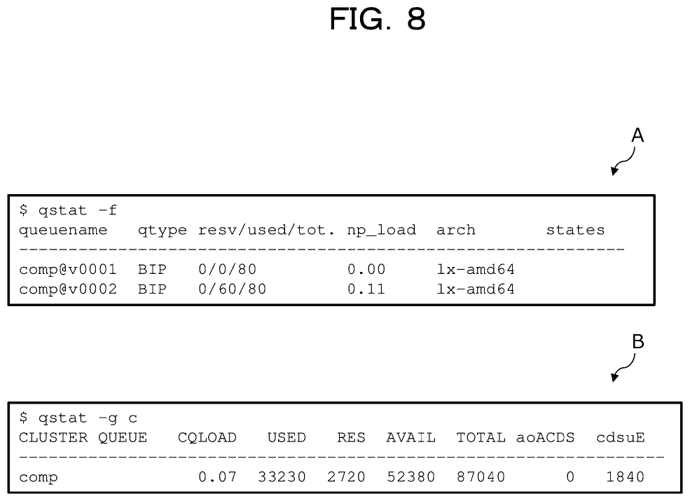

FIG. 8 is a diagram illustrating an execution example of a queue state display command in the information processing system 1 according to the one embodiment.

In FIG. 8, a reference sign A indicates an example in which a command (qstat -f) for displaying a resource status of each execution node 5 is executed.

The resource status of each execution node 5 is displayed in an execution result of the command. “resv” indicates a reserved resource amount, and “used” indicates a resource amount in use. In the execution result of this command, the execution node 5 with “resv/used” of “0/0” indicates an empty node. Accordingly, it is possible to count the number of empty nodes by searching for the execution node 5 having “resv/used” of “0/0”. When there are as many empty nodes as resources desired to be secured, it is considered that no waiting time occurs.

In FIG. 8, a reference sign B indicates an example in which a command (qstat -q c) for displaying a resource status of an entire cluster is executed.

The resource status of the entire cluster is displayed in the execution result of the command. “AVAIL” indicates an available resource amount, and “TOTAL” indicates a total resource amount. A smaller “AVAIL/TOTAL” ratio indicates a higher congestion. When the number of empty resources is small, it is considered that the waiting time is long.

A ratio between “resv” and “used” (“resv/used” ratio) or a ratio between “AVAIL” and “TOTAL” (“AVAIL/TOTAL” ratio) obtained from the result of the command for displaying the resource status described above may be input to the machine learning model (prediction model W) for predicting the waiting time.

For example, training (machine learning) of the prediction model W that predicts the waiting time T_{w} may be performed by using, as teacher data, the “AVAIL/TOTAL” ratio in a case where the number of empty execution nodes 5 is 0, and an actual measurement value of the generated waiting time.

For example, the prediction unit 63 predicts the waiting time T_{w}(n) when data parallel distributed training is performed in the execution node group 4 by using the prediction model W. T_{w}(n) is a waiting time taken to secure n execution nodes 5 as resources.

Based on the values calculated by the prediction unit 63, the parallel number determination unit 64 determines the number of execution nodes 5 (the execution node number and the parallel number) to be used when the distributed training is performed.

The parallel number determination unit 64 solves an optimum parallel number n from a formulated mathematical optimization problem based on Expression (1) below.

$$minimize α \frac{{T}_{w} ( n ) + {T}_{l} ( n )}{{T}_{w} ( 1 ) + {T}_{l} ( 1 )} + β \frac{n \cdot {T}_{l} ( n )}{{T}_{l} ( 1 )} \qquad ( 1 )$$

α and β are coefficients for determining which item is emphasized in the minimization. A term to which the coefficient α is added in Expression (1) above may be said to be a term related to an execution time. A term to which the coefficient β is added may be a term related to a cost, and increases in proportion to the execution node number n. For example, the cost may be a usage fee or the like for using the execution node 5.

In a case where minimization of the execution time is emphasized, α>β is set. In a case where minimization of the usage fee is emphasized, α<β is set.

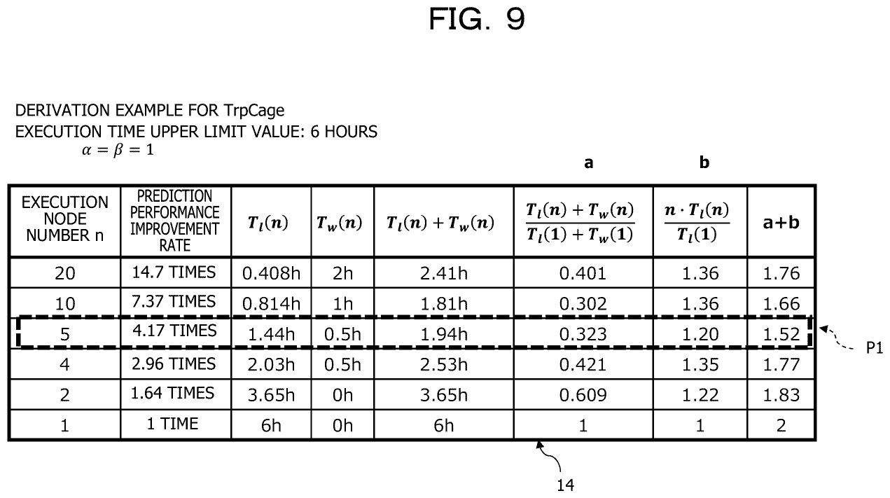

FIG. 9 is a diagram illustrating reference information 14 referred to by the parallel number determination unit 64 of the information processing system 1 according to the one embodiment.

For example, the parallel number determination unit 64 determines the execution node number by referring to the reference information 14 illustrated in FIG. 9.

In the reference information 14 illustrated in FIG. 9, the prediction performance improvement rate, Tₗ(n), T_{w}(n), {[Tₗ(n)+T_{w}(n)]/[Tₗ(1)+T_{w}(1)]}=a, n·Tₗ(n)/Tₗ(1)=b, and a+b are associated with the number of nodes.

In the reference information 14 illustrated in FIG. 9, it is assumed that the execution time upper limit value is 6 hours and α=β=1.

The number of nodes and the prediction performance improvement rate are the same as the execution node number and the prediction performance improvement rate of the prediction performance improvement rate information 15 indicated by the reference sign B in FIG. 7.

Tₗ(n) is a predicted value of the execution time for each execution node number, calculated by the prediction unit 63 based on the prediction performance improvement rate in the prediction performance improvement rate information 15.

T_{w}(n) is a waiting time predicted by the prediction unit 63 using the prediction model W and taken to secure n execution nodes 5 as resources.

Tₗ(1) is a predicted value of the execution time in a case where the execution node number is 1 (n=1), and Tₗ(1)=6 hours in the reference information 14 illustrated in FIG. 9. T_{w}(1) is a waiting time in a case where the execution node number is 1 (n=1), and T_{w}(1)=0 in the reference information 14 illustrated in FIG. 9.

{[Tₗ(n)+T_{w}(n)]/[Tₗ(1)+T_{w}(1)]} is a value calculated by using Tₗ(n), T_{w}(n), Tₗ(1), and T_{w}(1) described above. It is assumed that {[Tₗ(n)+T_{w}(n)]/[Tₗ(1)+T_{w}(1)]}=a. This value of a is an example of a first score related to the execution time.

n^{⋅}Tₗ(n)/Tₗ(1) is a value calculated by using Tₗ(n), T_{w}(n), Tₗ(1), and T_{w}(1) described above. It is assumed that n^{⋅}Tₗ(n)/Tₗ(1)=b. This value of b is an example of a second score related to the cost.

a+b is a sum of a calculated value of {[Tₗ(n)+T_{w}(n)]/[Tₗ(1)+T_{w}(1)]} and a calculated value of n^{⋅}Tₗ(n)/Tₗ(1). This value of a+b is an example of a score for each execution environment obtained based on the waiting time T_{w} and the execution time Tₗ obtained for each allocation pattern (execution environment).

By referring to the reference information 14, the parallel number determination unit 64 determines the execution node number n having a minimum value of a+b as the number of execution nodes 5 to be used for data parallel distributed training. In the example illustrated in FIG. 9, the parallel number determination unit 64 adopts, as the execution node number, the execution node number, 5 (n=5), for which the value of a+b is 1.52, which is the lowest.

The parallel number determination unit 64 determines the execution node number corresponding to an allocation pattern (execution environment) related to a minimum score among a plurality of scores (a+b) as the execution node number to be used for distributed training.

Based on Expression (1) above, the parallel number determination unit 64 functions as a solver that solves the optimum parallel number n from the formulated mathematical optimization problem.

The job deployment unit 61 inputs a distributed training job to the execution nodes 5, the number of which is the parallel number (the execution node number) determined by the parallel number determination unit 64. For example, the job deployment unit 61 allocates a job to the execution node 5.

For example, the job deployment unit 61 may preferentially allocate a job to an execution node 5 with a low load, or may determine an execution node 5 to which a job is to be allocated among the plurality of execution nodes 5 by using various known methods.

### (B) Operation

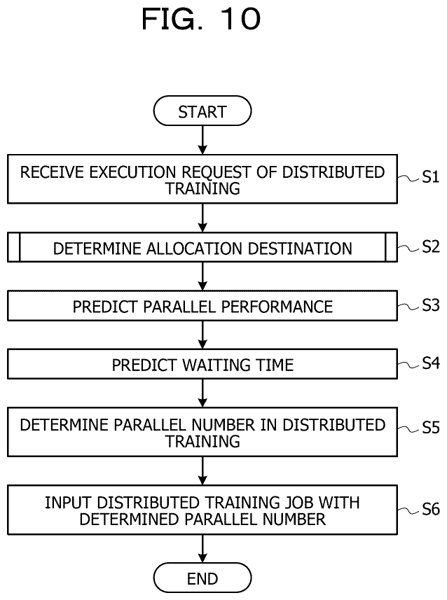

Processing of the system management device 6 of the information processing system 1 according to the one embodiment configured as described above will be described with reference to a flowchart (steps S1 to S6) illustrated in FIG. 10.

In step S1, the system management device 6 receives an execution request of distributed training, input from the client terminal 3 or the like.

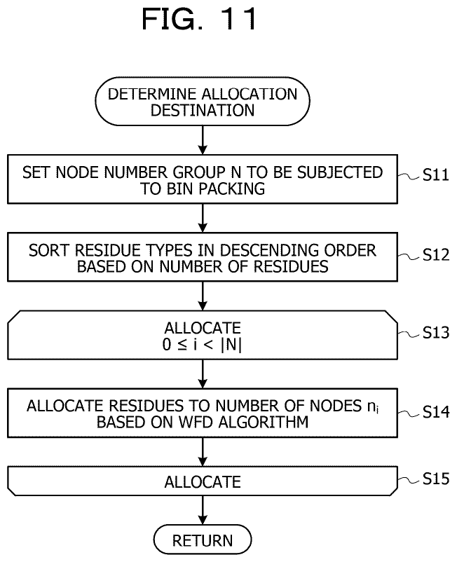

In step S2, the prediction unit 63 determines a job allocation destination. Details of this processing will be described later with reference to FIG. 11.

In step S3, the prediction unit 63 predicts an execution time (parallel performance) Tₗ(n) when distributed training is performed by using n execution nodes 5.

In step S4, the prediction unit 63 predicts a waiting time T_{w}(n) taken to secure the n execution nodes 5 as resources.

In step S5, the parallel number determination unit 64 determines the number of execution nodes 5 (the execution node number and the parallel number) to be used when distributed training is performed.

In step S6, the job deployment unit 61 inputs a distributed training job to the execution nodes 5, the number of which is the parallel number (the execution node number) determined by the parallel number determination unit 64. After the job management unit 62 confirms that the execution of the input job is completed, the processing ends.

Details of the processing in step S2 in the flowchart illustrated in FIG. 10 will be described with reference to a flowchart (steps S11 to S15) illustrated in FIG. 11.

In step S11, the prediction unit 63 sets a node number group N={n₁, n₂, . . . , n_{|N|-1}} (a plurality of allocation patterns) to be subjected to bin packing.

In step S12, the prediction unit 63 sorts residue types in descending order based on the number of residues for the residues constituting the protein.

In step S13, loop processing is started in which processing of step S14 is repeatedly executed for all elements (allocation patterns) i included in the set N of the node number group.

In step S14, residues are allocated to nᵢ execution nodes based on the WFD algorithm.

In step S15, loop-end processing corresponding to step S13 is executed. When the processing for all the allocation patterns included in the node number group is completed, the present flow ends.

### (C) Effects

As described above, according to the information processing system 1 according to the one embodiment, the prediction unit 63 obtains a waiting time T_{w} until a resource to be used for distributed training is secured and an execution time Ti taken for the distributed training for each allocation pattern in which the execution node number is different.

Based on the waiting time T_{w} and the execution time Ti obtained for each of these allocation patterns, the prediction unit 63 calculates a score (a+b) for each allocation pattern.

Based on Expression (1) above, the parallel number determination unit 64 solves the formulated mathematical optimization problem to find an optimum parallel number n. For example, the parallel number determination unit 64 determines an execution node number corresponding to an allocation pattern having the minimum score (a+b), as the number of nodes to be used for distributed training.

Accordingly, it is possible to set the optimum execution node number (parallel number) in terms of both the time and the cost. It is also possible to minimize the time (including the waiting time) from the job input to the execution completion.

By appropriately changing the values of α and β in Expression (1) above, it is possible to determine the execution node number in consideration of a balance between the cost and the execution time.

By causing the plurality of execution nodes 5 to process the NNs provided for the respective residue types constituting the protein, it is possible to calculate the potential energy of the protein.

The prediction unit 63 calculates a prediction performance improvement rate for each of a plurality of allocation patterns based on a cumulative computation time obtained by causing one execution node 5 among the plurality of execution nodes 5 to tentatively execute processing related to distributed training. The execution time Tₗ is calculated by reflecting the prediction performance improvement rate in the execution time upper limit value. Accordingly, it is possible to calculate the execution time Tₗ without predicting a training time (program execution time) of the NN in advance, which is difficult.

### (D) Others

The disclosed technique is not limited to the aforementioned embodiment but may be carried out with various modifications within a scope not departing from the gist of the present embodiment.

For example, in the above-described embodiment, the prediction unit 63 predicts the waiting time T_{w} by using the prediction model W, but the embodiment is not limited to this. For example, in a case where the system has a function of predicting a waiting time and a function of presenting an execution start prediction time for the input job, information on the presented execution start prediction time may be used.

The prediction unit 63 may use a second prediction model L to predict the execution time Tₗ(n) when the data parallel distributed training is performed.

For example, in a case where a predicted value is obtained from past execution results in the same manner as the prediction model W, the second prediction model L may be a machine learning model in which an allocation pattern of residues to each execution node as illustrated in FIG. 4 and an actual measurement value of an execution time for the allocation pattern are input as teacher data, and a time corresponding to the maximum computation time in FIG. 7 is output.

For example, the execution time Tₗ(n) may be obtained by calculating the prediction performance improvement rate using the reference information 14 exemplified in FIG. 9.

Although an example in which potential energy of a protein is calculated has been described in the above-described embodiment, the embodiment is not limited thereto. For example, the information processing system 1 may be used to calculate potential energy of a particle system other than a protein, and may be implemented with various modifications.

The above-described disclosure enables a person skilled in the art to carry out and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a processor of an information processing apparatus that manages distributed training that uses a plurality of nodes to execute a process, the process comprising:
obtaining a waiting time until a resource to be used for the distributed training is secured and an execution time taken for the distributed training, for each of execution environments of different numbers of nodes;
obtaining a score for each of the execution environments based on the waiting time and the execution time acquired for each of the execution environments; and
determining the number of nodes to be used for the distributed training based on a plurality of the scores.

2. The non-transitory computer-readable recording medium according to claim 1, wherein
the determined number of nodes to be used for the distributed training is the number of nodes corresponding to an execution environment corresponding to a minimum score among the plurality of scores.

3. The non-transitory computer-readable recording medium according to claim 1, wherein
the score includes a first score related to the execution time and a second score related to a cost.

4. The non-transitory computer-readable recording medium according to claim 1, further causing the processor to execute a process of:
calculating potential energy of a protein by causing the plurality of nodes to process NNs provided for respective residue types that constitute the protein.

5. The non-transitory computer-readable recording medium according to claim 1, wherein
the obtaining the execution time includes
calculating a prediction performance improvement rate for each of a plurality of the execution environments based on a measurement result obtained by causing one node among the plurality of nodes to execute processing related to the distributed training, and
calculating the execution time by reflecting the prediction performance improvement rate in an execution time upper limit value.

6. The non-transitory computer-readable recording medium according to claim 1, wherein
the obtaining the waiting time includes
acquiring the waiting time by inputting processing state information in the node to a machine learning model.

7. An information processing apparatus comprising:
a memory; and
a processor coupled to the memory and configured to:
obtain a waiting time until a resource to be used for the distributed training is secured and an execution time taken for the distributed training, for each of execution environments of different numbers of nodes;
obtain a score for each of the execution environments based on the waiting time and the execution time acquired for each of the execution environments; and
determine the number of nodes to be used for the distributed training based on a plurality of the scores.

8. The information processing apparatus according to claim 7, wherein
the determined number of nodes to be used for the distributed training is the number of nodes corresponding to an execution environment corresponding to a minimum score among the plurality of scores.

9. The information processing apparatus according to claim 7, wherein
the score includes a first score related to the execution time and a second score related to a cost.

10. The information processing apparatus according to claim 7, wherein
the processor calculates potential energy of a protein by causing the plurality of nodes to process NNs provided for respective residue types that constitute the protein.

11. The information processing apparatus according to claim 7, wherein
the processor:
calculates a prediction performance improvement rate for each of a plurality of the execution environments based on a measurement result obtained by causing one node among the plurality of nodes to execute processing related to the distributed training, and
calculates the execution time by reflecting the prediction performance improvement rate in an execution time upper limit value.

12. The information processing apparatus according to claim 7, wherein
the processor acquires the waiting time by inputting processing state information in the node to a machine learning model.

13. An information processing method for causing a processor of an information processing apparatus that manages distributed training that uses a plurality of nodes to execute a process, the process comprising:
obtaining a waiting time until a resource to be used for the distributed training is secured and an execution time taken for the distributed training, for each of execution environments of different numbers of nodes;
obtaining a score for each of the execution environments based on the waiting time and the execution time acquired for each of the execution environments; and
determining the number of nodes to be used for the distributed training based on a plurality of the scores.

14. The information processing method according to claim 13, wherein
the determined number of nodes to be used for the distributed training is the number of nodes corresponding to an execution environment corresponding to a minimum score among the plurality of scores.

15. The information processing method according to claim 13, wherein
the score includes a first score related to the execution time and a second score related to a cost.

16. The information processing method according to claim 13, further causing the processor to execute a process of:
calculating potential energy of a protein by causing the plurality of nodes to process NNs provided for respective residue types that constitute the protein.

17. The information processing method according to claim 13, wherein
the obtaining the execution time includes
calculating a prediction performance improvement rate for each of a plurality of the execution environments based on a measurement result obtained by causing one node among the plurality of nodes to execute processing related to the distributed training, and
calculating the execution time by reflecting the prediction performance improvement rate in an execution time upper limit value.

18. The information processing method according to claim 13, wherein
the obtaining the waiting time includes
acquiring the waiting time by inputting processing state information in the node to a machine learning model.
